(19) United States
(12) Patent Application Publication
(10) Pub. No.: US 2012/0030627 A1
(43) Pub. Date: Feb. 2, 2012

(54) EXECUTION AND DISPLAY OF APPLICATIONS

(75) Inventors: Mikko Antero Nurmi, Tampere (FI); Andreea Ligia Chelaru, Amsterdam (NL)

(73) Assignee: Nokia Corporation

(21) Appl. No.: 12/847,463

(22) Filed: Jul. 30, 2010

(51) Int. Cl. G06F 3/048

(52) U.S. Cl. 715/835

(57) ABSTRACT

Apparatus comprises at least one processor, at least one memory including computer program code, where the at least one memory and the computer program code are configured, with the at least one processor, to cause the apparatus at least to store an identifier associated with a first application-type data item that is caused to be displayed during execution and display of a first application, and subsequent to removing the first application from the display, when executing a second application, automatically to cause a second application-type data item associated with the stored identifier to be displayed or automatically to cause to be displayed a selectable option, the selectable option being for causing a second application-type data item associated with the stored identifier to be displayed.

### FIELD

The invention relates to the execution and display of applications.

### BACKGROUND

Modern electronic apparatuses, such as mobile telephones, are capable of executing multiple software applications and in some instances are capable of executing multiple applications simultaneously.

### SUMMARY

According to a first aspect, this specification describes apparatus comprising: at least one processor; at least one memory including computer program code, where the at least one memory and the computer program code are configured, with the at least one processor, to cause the apparatus at least: to store an identifier associated with a first application-type data item that is caused to be displayed during execution and display of a first application; and subsequent to removing the first application from the display, when executing a second application, automatically to cause a second application-type data item associated with the stored identifier to be displayed or automatically to cause to be displayed a selectable option, the selectable option being for causing a second application-type data item associated with the stored identifier to be displayed.

According to a second aspect, this specification describes a method comprising: storing an identifier associated with a first application-type data item that is caused to be displayed during execution and display of a first application; and subsequent to removing the first application from the display, when executing a second application, automatically causing a second application-type data item associated with the stored identifier to be displayed or automatically causing to be displayed a selectable option, the selectable option being for causing a second application-type data item associated with the stored identifier to be displayed.

According to a third aspect, this specification describes a non-transitory computer-readable storage medium having stored thereon computer-readable code, which, when executed by computing apparatus, causes the computing apparatus, during a communication session with remote apparatus: to store an identifier associated with a first application-type data item that is caused to be displayed during execution and display of a first application; and subsequent to removing the first application from the display, when executing a second application, automatically to cause a second application-type data item associated with the stored identifier to be displayed or automatically to cause to be displayed a selectable option, the selectable option being for causing a second application-type data item associated with the stored identifier to be displayed.

This specification also describes computer readable instructions, which when executed by computing apparatus cause the computing apparatus to perform a method according to the second aspect.

This specification also describes apparatus comprising: means for storing an identifier associated with a first application-type data item that is caused to be displayed during execution and display of a first application; and means for automatically causing, subsequent to removing the first application from the display, when executing a second application, a second application-type data item associated with the stored identifier to be displayed or automatically causing to be displayed a selectable option, the selectable option being for causing a second application-type data item associated with the stored identifier to be displayed.

### BRIEF DESCRIPTION OF THE DRAWINGS

For a more complete understanding of example embodiments of the present invention, reference is now made to the following description taken in connection with the accompanying drawings in which:

FIG. 1 is a block diagram of electronic apparatus according to example embodiments of the invention;

FIGS. 2A-2S show the electronic apparatus of FIG. 1 performing operations according to example embodiments of the invention;

FIGS. 3A-3C show the electronic apparatus of FIG. 1 performing operations according to example embodiments of the invention;

FIGS. 4A-4I show the electronic apparatus of FIG. 1 performing operations according to example embodiments of the invention; and

FIG. 5 is a flow diagram depicting operations according to example embodiments of the invention.

### DETAILED DESCRIPTION OF THE EMBODIMENTS

In the description and drawings, like reference numerals refer to like elements throughout.

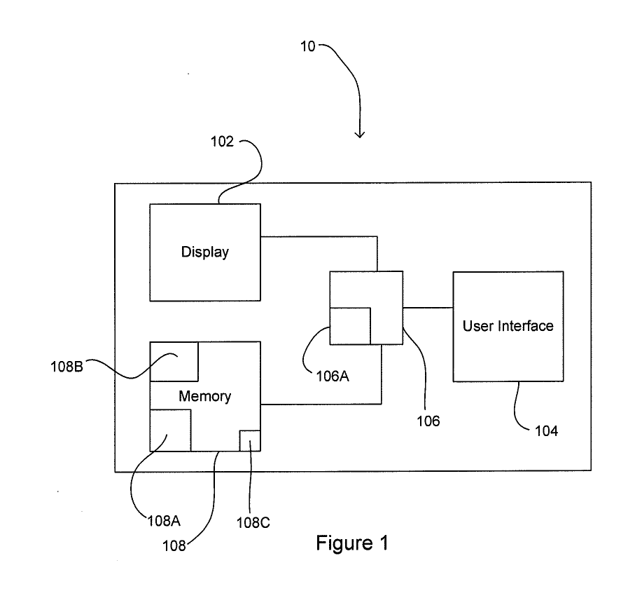

FIG. 1 is a simplified schematic of electronic apparatus 10 according to example embodiments of the present invention. The electronic apparatus 10 comprises a display unit 102, a user interface 104, a controller 106, and a memory 108.

The display unit 102 is operable to display visual information to a user of the electronic apparatus 10. The user interface 104 is operable to receive user inputs from the user. The controller 106 is configured to receive from the user interface 104 signals indicative of user inputs received by the user interface 104. The controller 106 is configured to alter the output of the display unit 102 based on the signals received from the user interface 104. The controller 106 includes one or more processors 106A operating under the control of computer-readable code 108A stored in the memory 108. The controller 106 may also comprise one or more application specific integrated circuits (ASICs) (not shown).

The display unit 102 may comprise any suitable type of display, for example but not limited to, an LED display, a plasma display, LCD display or an OLED display. The user interface 104 may comprise a touch-sensitive transducer 104, such as but not limited to a capacitive touch-sensitive panel and a resistive touch-sensitive panel, operable to receive touch inputs from the user. In such example embodiments, the touch-sensitive transducer 104 may be overlaid on the display unit 102 to form a touchscreen 102, 104. Alternatively, the user interface 104 may comprise a different type of user interface 104, such as a keypad, a scroll wheel, a track ball etc.

The memory 108 may comprise one or more distinct memory units. The one or more memory units may be of any suitable type. For example, the one or more memory 108 units may comprise non-transitory, removable or non-removable, memory media such as but not limited to ROM, RAM, EEPROM etc. or any combination thereof.

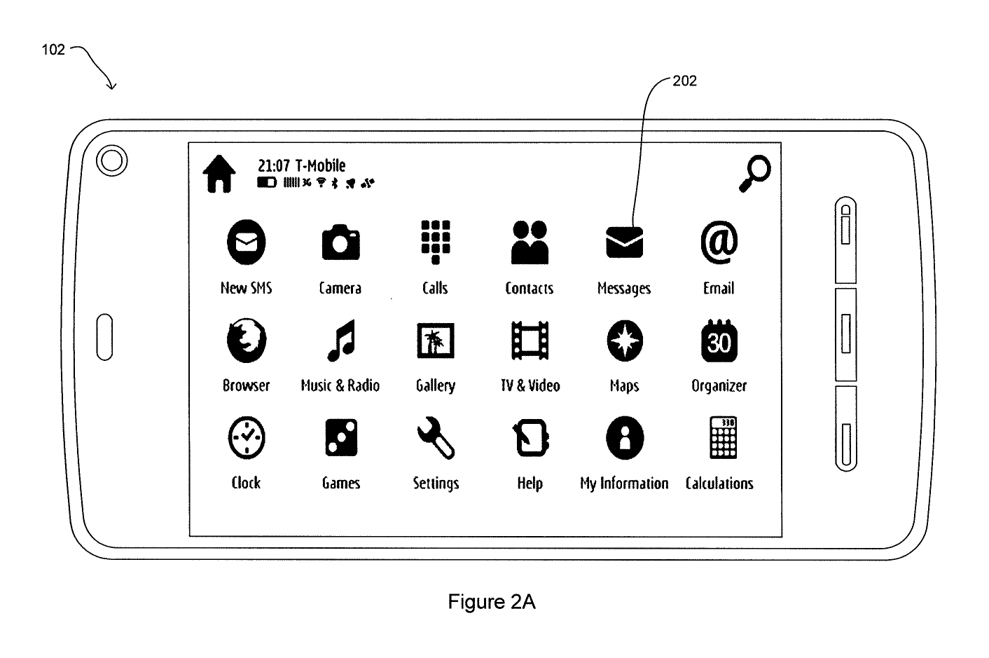

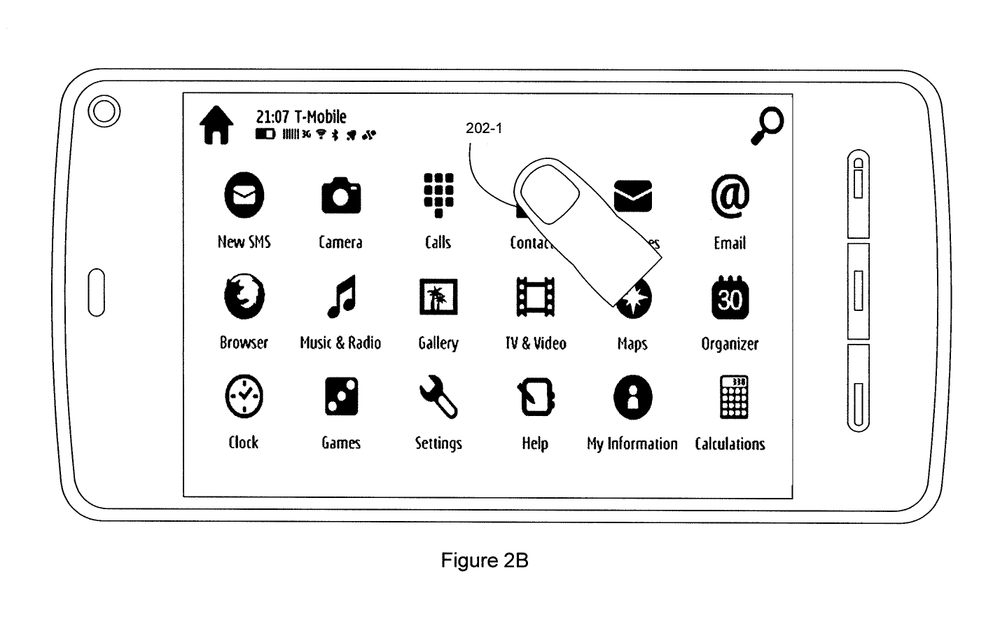

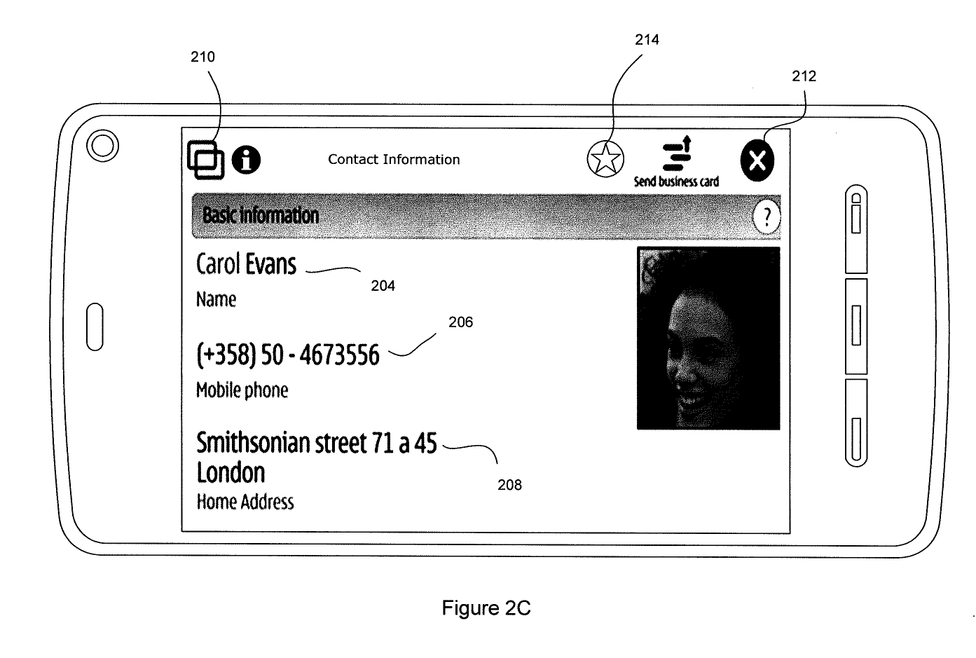

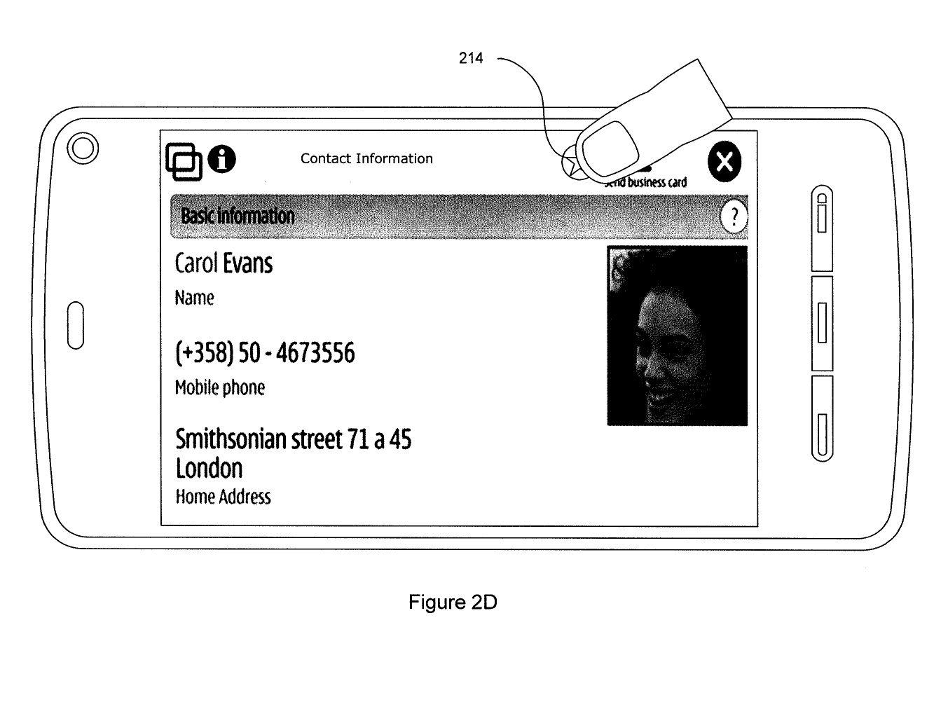

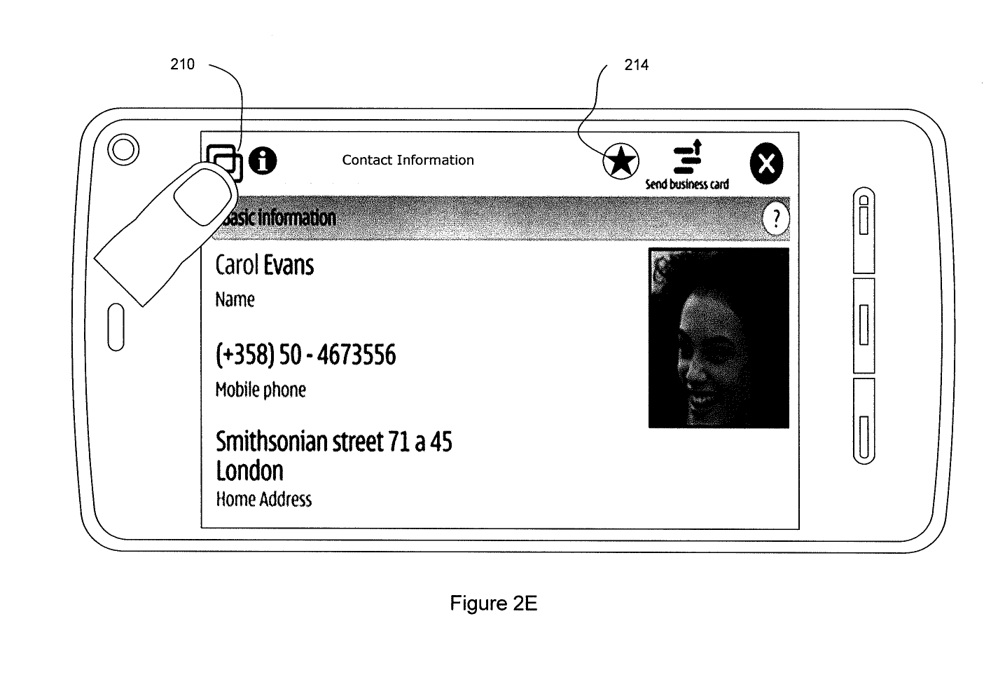

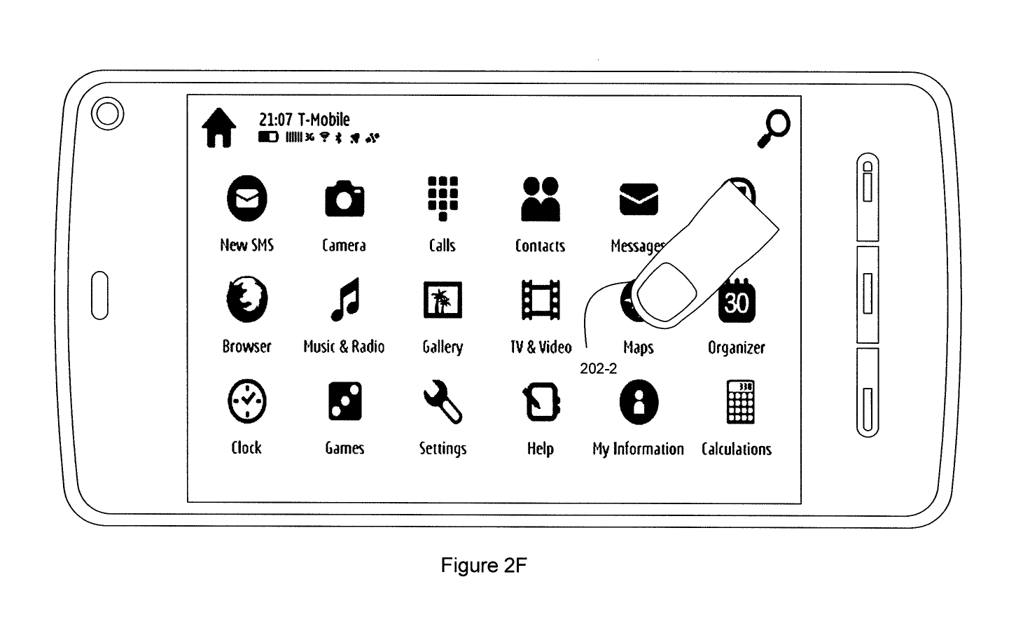

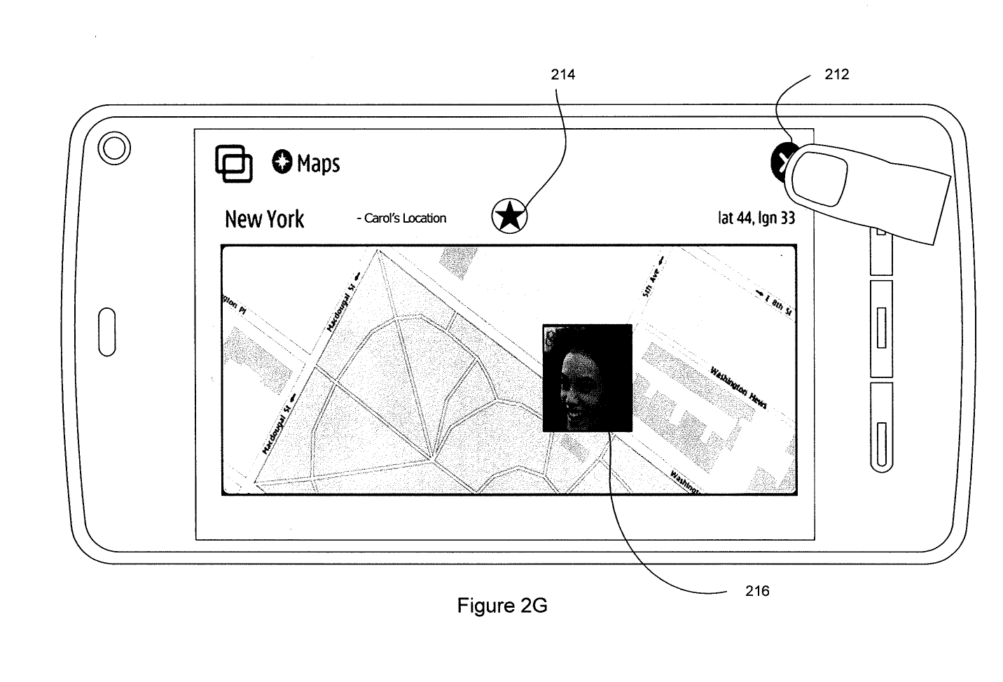

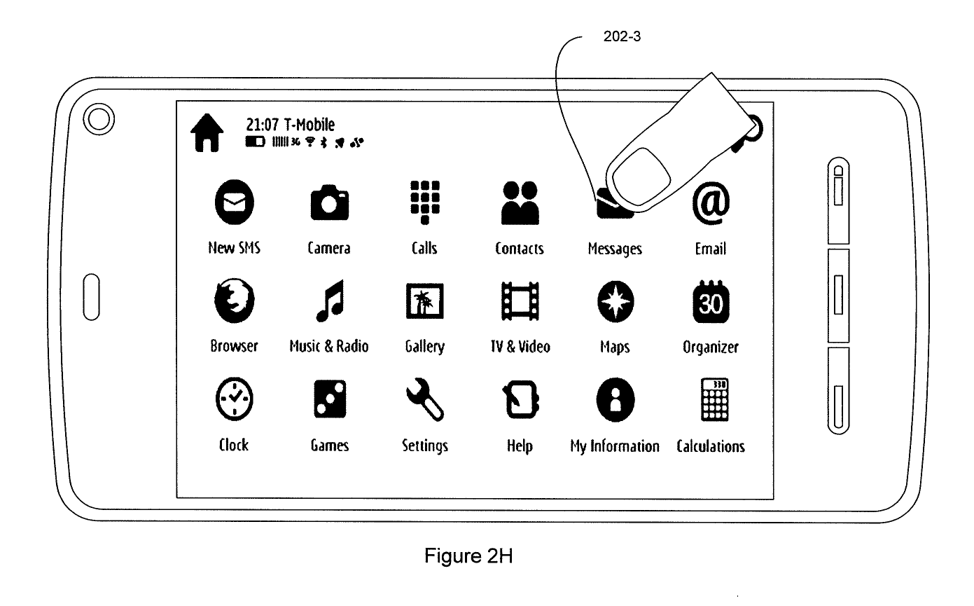

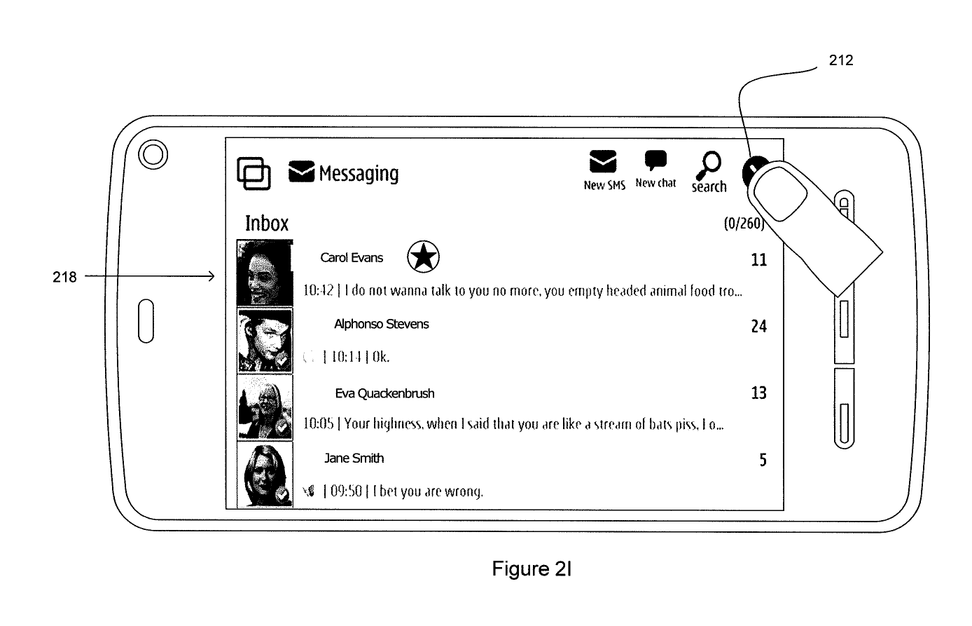

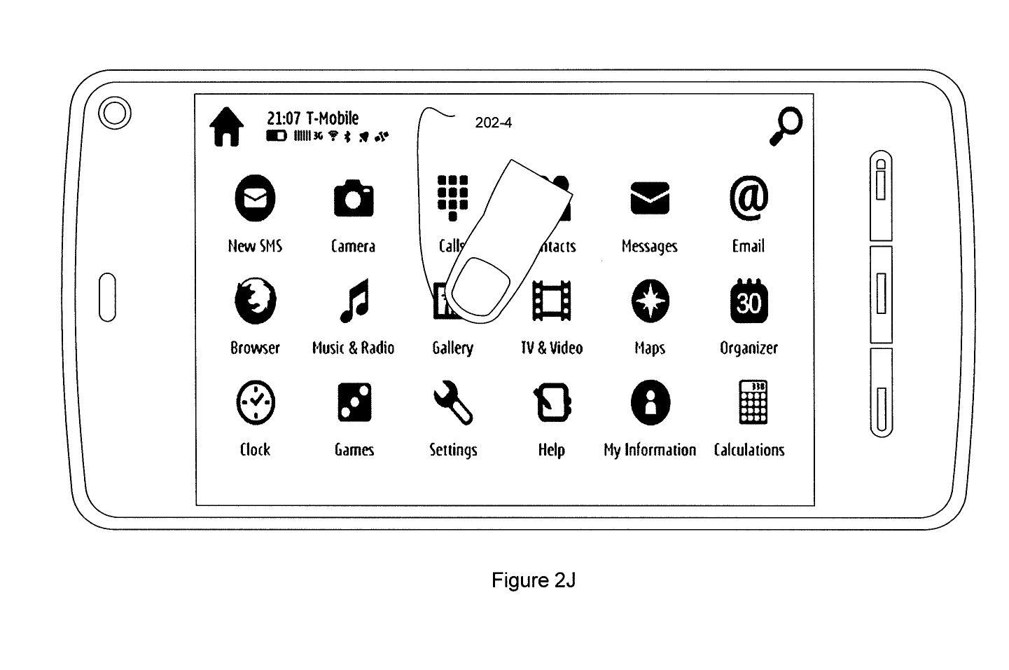

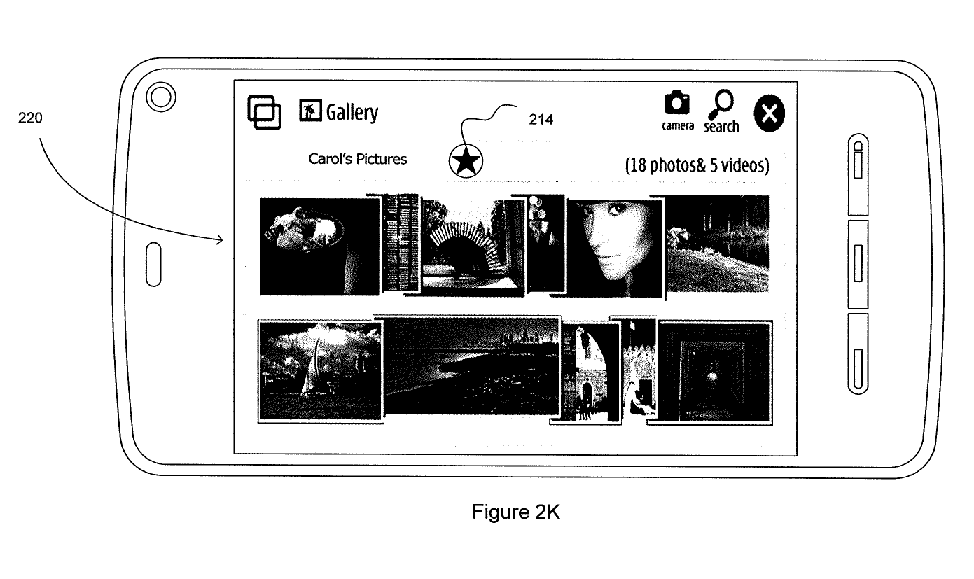

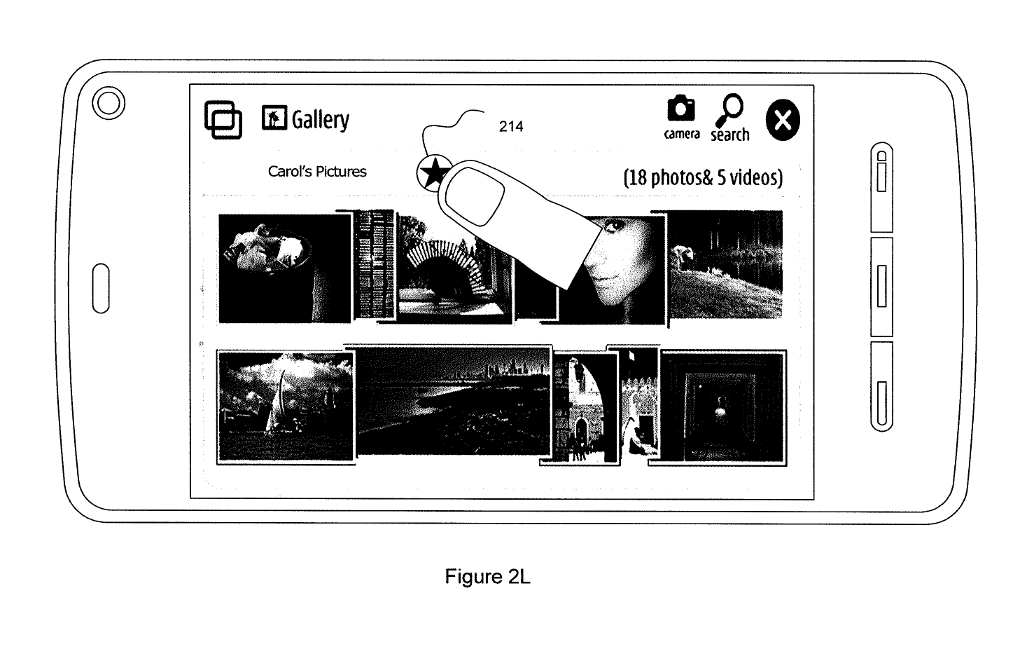

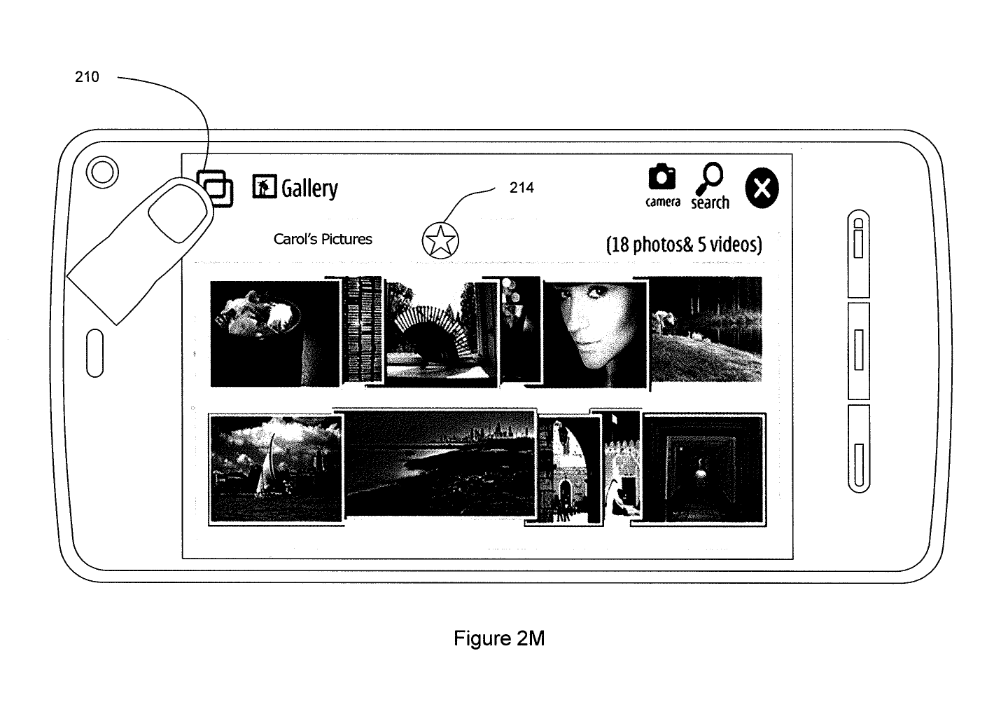

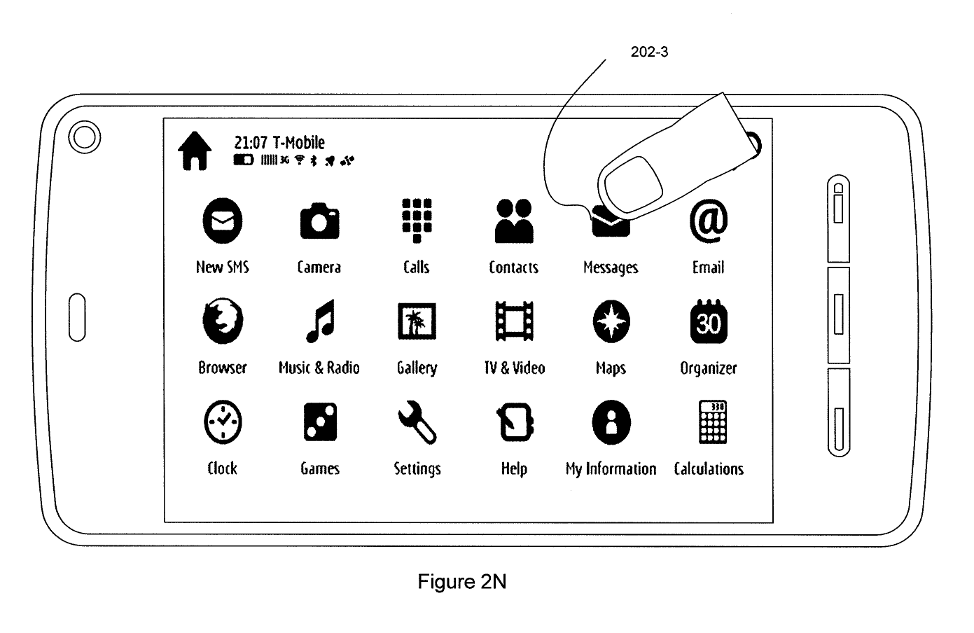

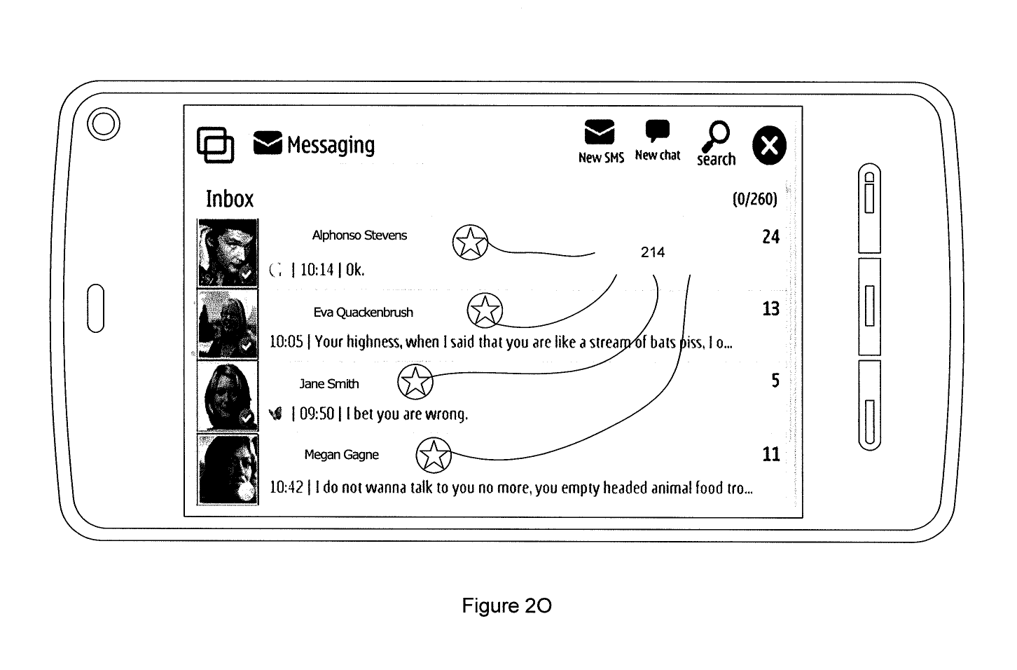

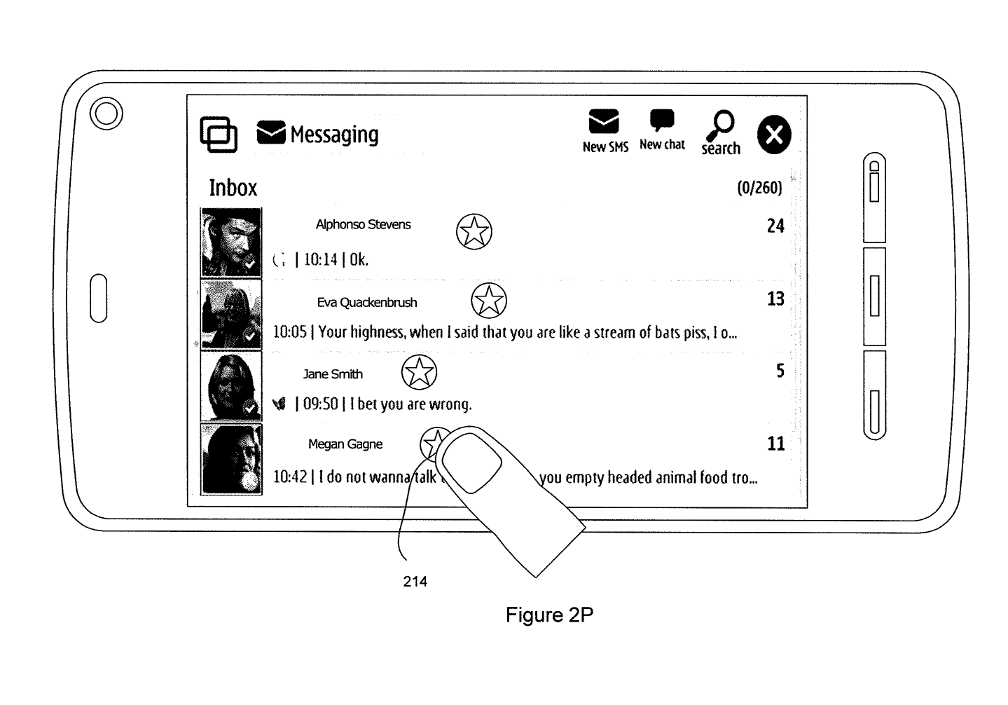

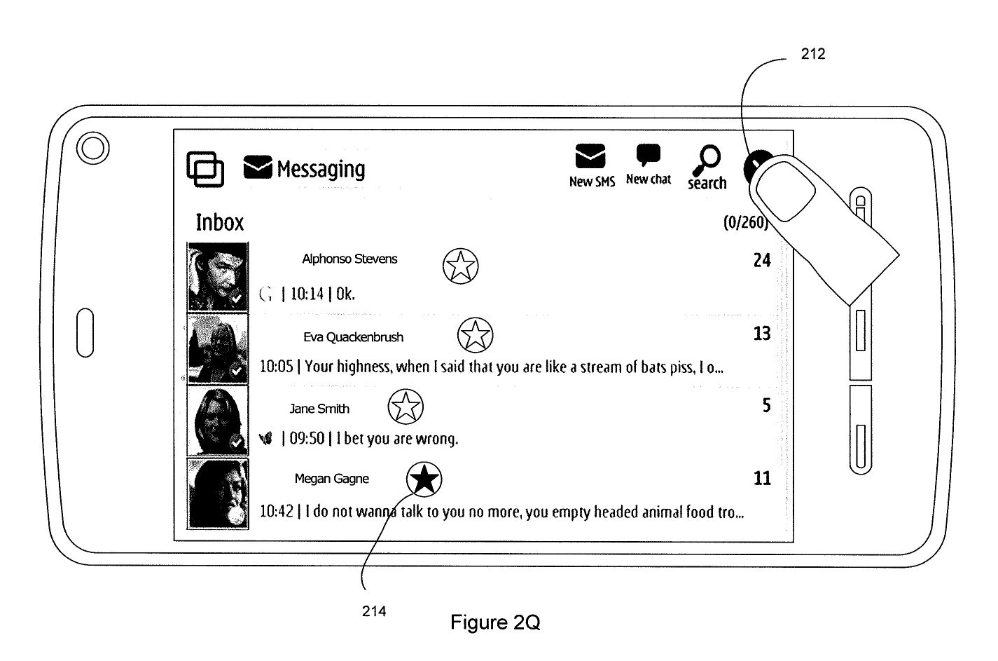

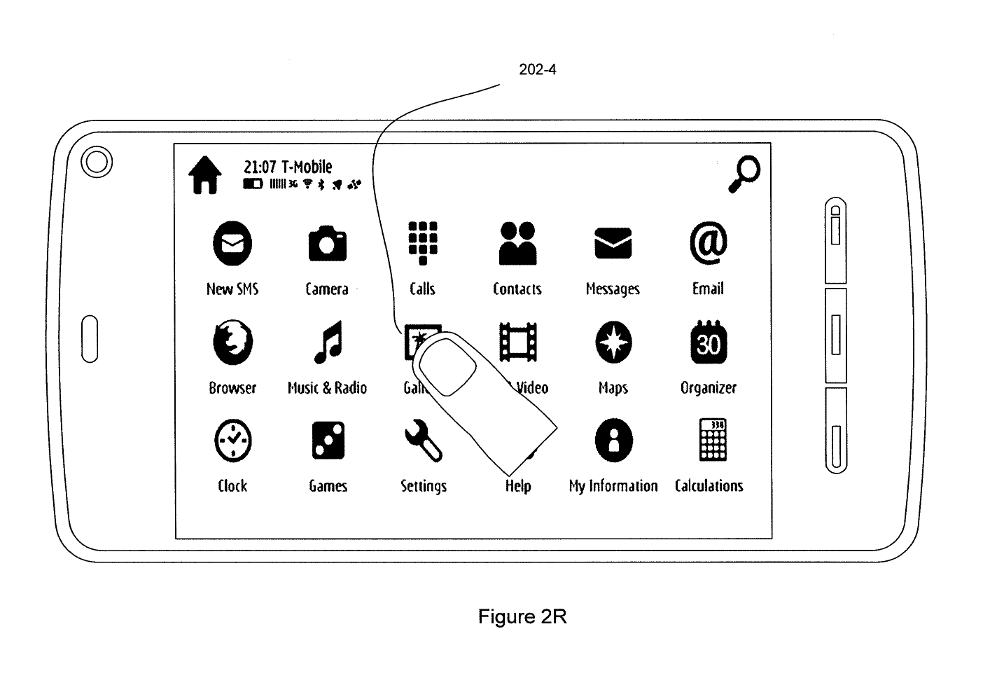

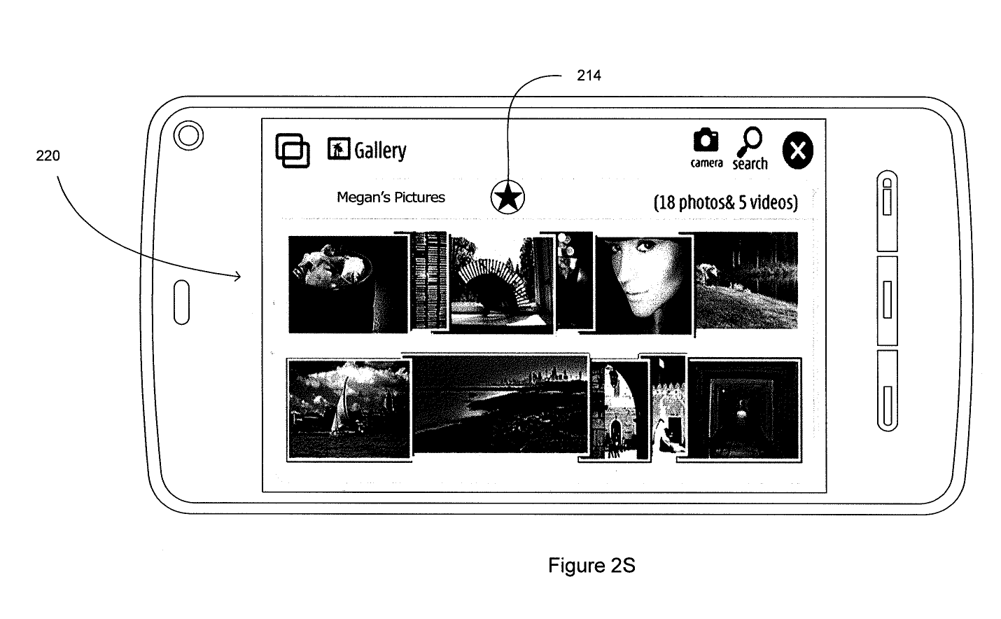

FIGS. 2A-2S show operations of the electronic apparatus 10 of FIG. 1 according to example embodiments of the invention.

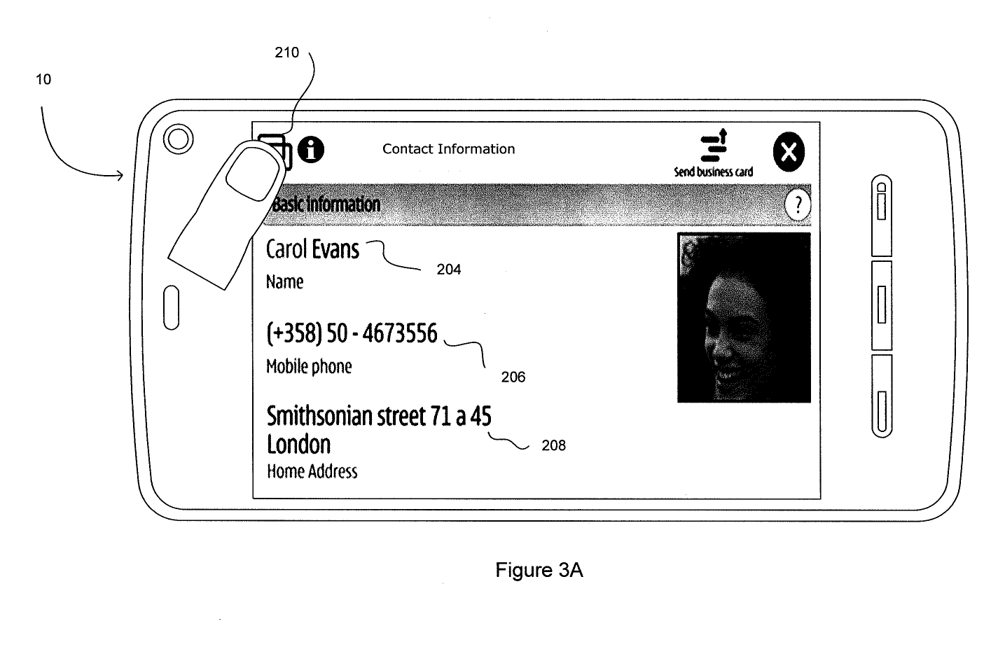

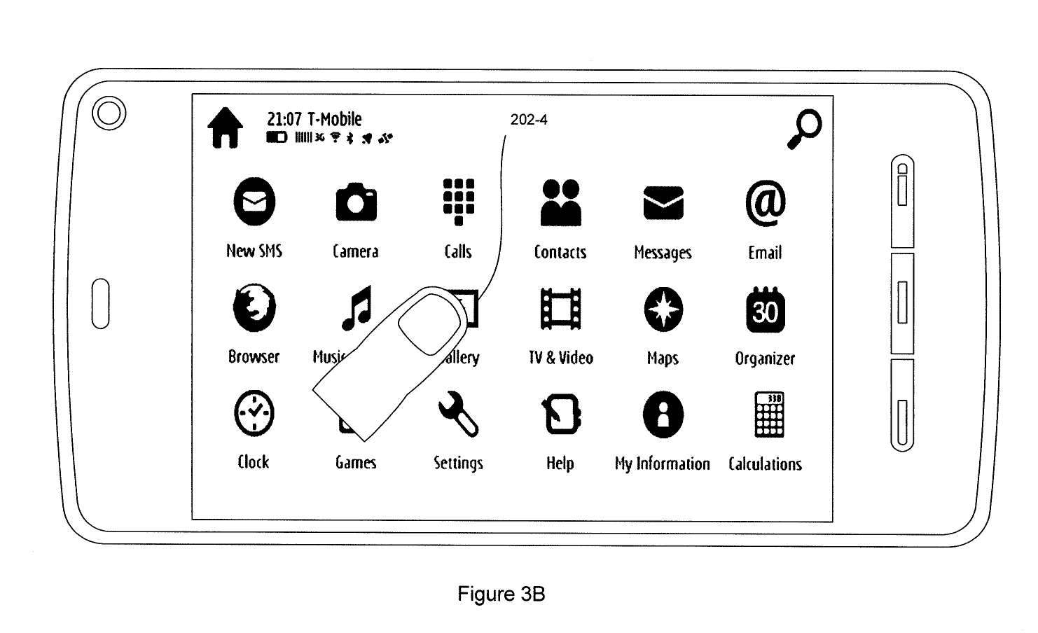

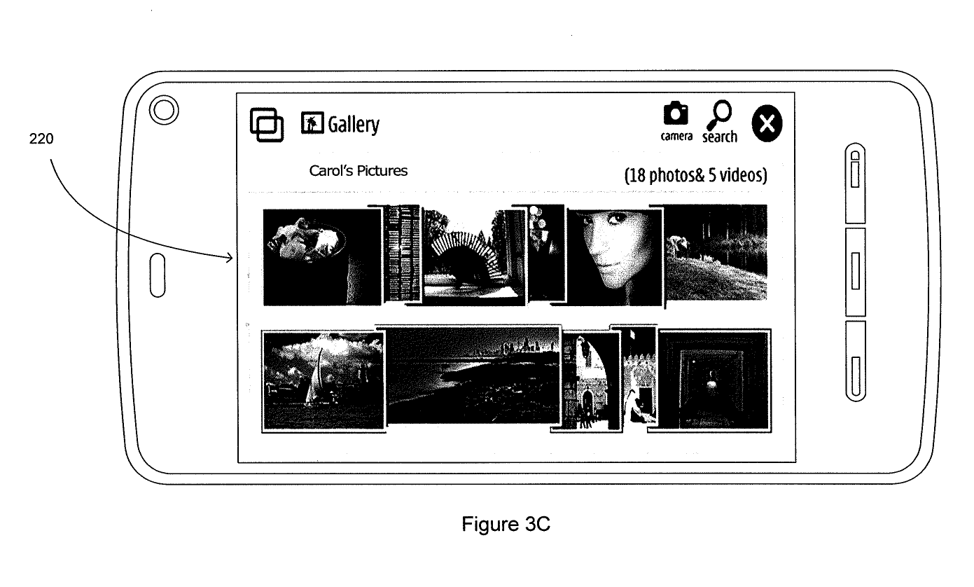

In the example of FIGS. 2A-2S and FIGS. 3A-3C, the electronic apparatus 10 is a mobile telephone. However, it will be understood that the electronic apparatus 10 may be of another type, such as but not limited to, a personal digital assistant, a tablet computer, a laptop computer, a personal computer, a wearable computer, a digital music player etc.

In the examples of FIGS. 2A-2S and FIGS. 3A-3C, the user interface 104 comprises a touch-sensitive transducer 104 overlaid on the display unit 102 to form a touchscreen 102, 104. It will be appreciated however that, according to other example embodiments of the invention, the user interface 104 may be of a different type.

In FIG. 2A, the controller 106, under the control of computer-readable code 108A, is causing the display unit 102 to display an array of icons 202. Each of the array of icons 202 is selectable by a user by providing a touch input to the touch-sensitive transducer 104 at a location corresponding to the location on the display unit 102 at which the icon 202 is being displayed. Each of the icons represents an application. Thus the array of icons 202 forms an application menu for allowing a user to select an application for execution by the electronic apparatus 10. Hereafter the array of icons 202 will be referred to as the “menu screen”. The applications comprise computer-readable code 108A stored in the memory 108A. As will be appreciated from the following description, the operations according to the invention may be caused to be performed by the computer-readable code of an operating system, by the computer-readable code of applications, by the computer-readable code of user interface software, or by any combination of these three.

Upon receipt of signals from the touch sensitive transducer 104 indicative of the user selection of one of the icons 202 displayed on the menu screen, the controller 106 is operable to cause an application associated with the selected icon 202 to be executed, run or launched. Following execution of a selected application, the controller 106 is operable to cause information generated by the application to be displayed on the display unit 102.

In FIG. 2B, the user of the electronic apparatus 10 applies a touch input to a region of the touch-sensitive transducer 104 which corresponds to a location on the display unit 102 at which an icon 202-1 representing a “contacts application” is being displayed. The “contacts application” may be one in which the user is able to view information about their contacts.

In response to receiving signals indicative of a selection of the contacts application, the controller 106 executes the contacts application and causes to be displayed on the display unit 102 information generated by the contacts application.

In the example of FIG. 2C, the information generated by the contacts application comprises “contact information” relating to a single contact. In this example, the contact information comprises the name 204, telephone number 206 and address 208 of a contact, “Carol Evans”.

The contact information for a particular contact may be termed a “contact application data item”. The contact application data item in this example comprises a contact's name, telephone number and address. Plural contact application data items may be stored in the memory 108 and may be identified and retrieved from, for example, a database 108B stored in the memory 108, using an identifier. The identifier may be, for example, the contact's name or a unique number associated with that contact. Thus, when executed by the controller 108, the computer-readable code 108A of the application is operable to identify a particular data item from the memory 108, and to cause the data item to be displayed on the display unit 102.

Also displayed by the contacts application are a “minimise” option icon 210, an “exit” option icon 212 and a “set active contact” icon 214. Each of these is selectable in response to a user input on a region of the touch-sensitive transducer 104 corresponding to a location of the display unit 102 at which the particular icon is displayed.

In response to receiving an indication of the selection of the “minimise” option icon 210, the controller 106 is operable to cause the current application, in this example the contacts application, to be minimised, or removed from the screen, and the menu screen to be displayed. When the minimise option icon 210 is selected, the application is not exited but is instead kept running in the background. In response to receiving an indication indicative of selection of the “exit” option icon 212, the controller 106 causes the current application to be exited and subsequently causes the menu screen to be displayed.

In FIG. 2D, the user applies a touch input to the “set active contact” option icon 214. In response to receiving signals indicative of this selection, the controller 106 causes the identifier associated with the contact application data item 204, 206, 208 currently being displayed on the display unit 102 to be stored in the memory 108. This identifier may be stored in a dedicated field 108C in the memory 108.

Additionally, as can be seen in FIG. 2E, the controller 106 may cause the appearance of the set active contact icon 214 to be altered. In the example of FIG. 2, prior to selection, the set active contact icon 214 comprises a white star in a white circle. After selection, the icon 214 comprises a black star in a white circle. This allows the user easily to recognise that the contact associated with the currently displayed contact application data item is the active contact. It will be appreciated that the icon comprising a star in a circle is an example only and that any other suitable type of indication may be used to indicate that a particular contact is an active contact. For example, this may include but is not limited to another type of icon, a coloured border around a contact's name or image, an audible indication, a tactile indication such as a vibration, or any combination of these.

As shown in FIG. 2E, subsequent to selecting the contact associated with the currently displayed data item as the active contact, the user selects the minimise option icon 202, which as can be seen in FIG. 2F, causes the contact application to be minimised and the menu screen to be displayed. Alternatively, the same actions can be achieved by the user selecting a ‘menu’ input, which may exist for instance as a hardware key or as a touchscreen input outside of the area of the display that is allocated to the contacts application. It will, of course, be appreciated that the application may be removed from display in any suitable manner.

In FIG. 2F, the user applies a touch input to an icon 202-2 associated with a second, different application, in this instance a “maps application”.

In response to receiving signals indicative of selection of the maps application, the controller 106 causes the maps application to be executed. As can be seen in FIG. 2G, this causes mapping information generated by the maps application to be displayed on the display unit 102. During initialisation of the maps application, the controller 106 checks the dedicated field 108C in the memory 108 to determine if an identifier associated with an active contact is stored therein. If the field 108C is empty, the controller 108 determines that the no active contact is set. In this example, the controller determines that an identifier associated with the contact “Carol Evans” is stored in the memory 108. In response to determining this, the controller 106 causes a “map application data item” associated with the stored identifier to be displayed. In this example, the map application data item associated with the identifier comprises a picture 216 of Carol Evans which is located at a region of a map representing her current location. Her current location may be determined based on signals received from, for example, a server or a device associated with Carol Evans. As such, the data item may comprise a section of a map associated with the coordinates of Carol's current location. Alternatively, the map application could instead display a map of Carol's home address. Thus, the application may not need to receive coordinates from Carol's device or from a server, but could instead have the coordinates of Carol's home address pre-stored in the memory 108 and associated with the identifier representing Carol Evans.

It will thus be understood from the above that, during initialisation of an application, the controller 106 examines the memory 108, for example the dedicated field 108C to determine if an active contact is set. If the controller 106 finds that an identifier is stored in the dedicated field 108C, it determines that an active contact is set. Subsequently, the controller 106 uses the stored identifier to identify a data item that is associated with the stored identifier from a plurality of data items associated with the application being initialised, which are stored in the database 108B. Next, the controller 106 causes the data item associated with the identifier to be displayed on the display unit 102.

As can be seen in FIG. 2G, also displayed by the map application is the set active contact icon 214. As Carol Evans is currently set as the active contact, the appearance of the set active contact icon 214 is indicative of such. Next, as can be seen in FIG. 2G, the user selects the exit option icon 212 which causes the map application to be exited.

Subsequently, as can be seen in FIG. 2H, the menu screen is displayed. Next, the user applies a touch input to an icon 202-3 associated with a “messaging application”. In response to receiving signals indicative of the selection of the messaging application, the controller 106 causes the messaging application to be launched.

During the launching of the messaging application, the controller 106 checks the dedicated field 108C to determine if an identifier is stored therein, thereby to determine if an active contact is set. In this example, Carol Evans is set as the active contact and thus an identifier associated with Carol Evans is stored in the dedicated field. As such, using the stored identifier associated with Carol Evans, the controller 106 causes “messaging application data items” 218 associated with the stored identifier to be identified. In this example, the messaging application data items 218 comprise messages received from Carol Evans. It will be understood that the messaging application data items alternatively or additionally may be, for example, messages sent to Carol Evans or draft messages to Carol Evans. Next, having identified the messaging application data items associated with the stored identifier, the controller 106, under control of the computer-readable code 108A, causes the identified messaging application data items 218 to be displayed on the display unit 102.

According to some embodiments, the application may display only data items associated with the stored identifier (as was the case with the mapping application). Alternatively, as can be seen in FIG. 2I, the application may display also data items which are not associated with the stored identifier. As such, in FIG. 2I, the messages from Carol Evans are displayed in addition to messages from other contacts. The data items associated with the stored identifier may be displayed in a more prominent way than the other data items. For example, in FIG. 2I, the messages received from the active contact, Carol Evans, are displayed at the top of a list of messages. Alternatively, the data items associated the stored identifier may be displayed more prominently than the other data items by, for example, highlighting or enlarging the data items associated with the stored identifier with respect to the other data items, using a bigger or different font for text related to the active contact, showing more text from messages associated with the active contact or by including additional image content associated with the active contact. The messaging application may also display the set active contact icon 214 to indicate that Carol Evans is the active contact.

Next, as can be seen in FIG. 2I, the user selects the exit option which causes the messaging application to be exited and, as shown in FIG. 2J, the menu screen to be displayed.

In FIG. 2J, the user selects an icon 202-4 associated with a “gallery application”. A gallery application may be one in which still images, such as photographs, can be viewed by the user of the electronic apparatus 10. In response to receiving signals indicative of selection of the gallery application icon 202-4, the controller 106 launches the gallery application. During initialisation of the gallery application, a controller 106 determines, by examining the dedicated field 108C, if an active icon 202 is set. As Carol Evans is set as the active contact, the controller 106 discovers that the identifier associated with Carol Evans is stored in dedicated field 108C. Next, the controller 106 uses the stored identifier to identify “gallery application data items” associated with the stored identifier from plurality of gallery application data items stored in the memory 108. In this example, the gallery application data items 220 comprise pictures received from Carol Evans. However, it will be understood that the gallery application data items associated with the stored identifier could alternatively be, for example, pictures including Carol Evans, as may be determined from tags included with the pictures. Following identification of the gallery application data items 220 associated with the stored identifier, the controller 106 causes these data items 220 to be displayed on the display unit 102.

Also displayed by the gallery application is the set active contact icon 214 which indicates that Carol Evans is the active contact. In FIG. 2L, the user applies a touch input to the set active contact icon 214. In response to receiving signals indicative of selection of the set active contact icon 214, the controller 106 removes the stored identifier associated with Carol Evans from the dedicated field 108C in the memory 108. Also, as can be seen in FIG. 2M, the controller 106 causes the appearance of the set active contact icon 214 to be altered so that it indicates that Carol Evans is not set as the active contact. Thus, the black star on the set active contact icon 214 is replaced by a white star. It will be appreciated that the same can occur in respect of the same icon in other displays, for instance those shown in FIGS. 2G and 2I. Next, the user selects the minimise option icon 210, which causes the controller 106 cause the gallery application to be minimised and the menu screen to be displayed.

In FIG. 2N, the user selects the messaging application icon 202-3. In response to receiving an indication of the selection of the messaging application icon 202-3, the controller 106 causes the messaging application to be launched. During initialisation of the messaging application, the controller 106 checks the dedicated field 108C to determine if an active contact is set and determines that no identifier is stored in the dedicated filed 108C and, thus, that an active contact is not set. In response to determining that no active contact is set, the controller 106 causes the messaging application to operate its usual manner and thereby to display, for example, most recently received messages as the most prominent messages.

As can be seen in FIG. 2O, the messaging application also displays plural set active contact icons 214, one for each contact. In this way, the user is able to select an active contact using the messaging application. As seen in FIG. 2P, the user applies a touch input to one of the plurality of set active contact icons 214.

In response to receiving indication of the selection of the set active contact icon 214, the controller 106 causes an identifier associated with the active contact to be stored in the memory 108.

In the example of FIGS. 2P and 2Q, the active contact is “Megan Gagne”. Thus the controller 106 causes an identifier associated with the contact Megan Gagne to be stored in the memory 108. The identifier may comprise the name Megan Gagne or a unique number or other identifier associated with the active contact. In addition, the controller 106 may cause the appearance of the set active contact icon 214 to be altered.

It will be understood that, although they were not shown in FIG. 2I, other set active contact icons 214, indicating that the associated contact is not the active contact, may be displayed in association with the other contacts which have associated data items displayed on the display unit 102. The user may be able to change between active contacts by de-selecting the active contact and then selecting a set active contact icon 214 associated with a different contact. Thus, the controller 106, in response to receiving de-selection of a currently active set active contact icon, deletes the stored identifier from the dedicated field. Subsequently, in response to an indication of selection of a new active contact, the controller 106 causes an identifier associated with the new active contact to be stored in the dedicated field 108C. Alternatively, selection of the set active contact icon 214 of a new, non-active contact may cause the non-active contact to become the active contact and the previously active contact to become a non-active contact. Thus, in response to receiving indication of selection of a new active contact, the controller 106 causes the stored identifier associated with the previous active contact to be replaced in the dedicated field 108C by identifier associated with the new active contact.

Next, returning to FIG. 2Q, the user selects the exit option icon 212 which, as can be seen in FIG. 2R, causes the messaging application to be exited and the menu screen to be displayed.

In FIG. 2R, the user again selects the gallery application icon 202-4 from the menu screen. Thus, the controller 106 causes the gallery application to be launched. During initialisation of the gallery application, the controller 106 determines if an active contact is set. In this instance, the controller 106 determines, based on the identifier stored in the dedicated field 108C, that the active contact is Megan Gagne. Using the stored identifier associated with Megan Gagne, the controller 106 identifies gallery application data items, in this instance pictures from Megan or pictures including Megan, and causes them to be displayed by the gallery application.

In the above examples, the user sets an active contact by selecting the set active contact icon 214. However, it will be understood that an active contact may be set in any suitable way. For example, by applying a particular gesture, such as a “double-tap” touch input comprising two touch inputs in quick succession, to a region of the touch-sensitive transducer 104 which corresponds to a region of the display unit 102 upon which information relating to the contact they wish to set as the active contact is displayed. Alternatively, the gesture may not require actual physical contact with the touch screen. In one alternative example embodiment, a voice input may be utilised to the set the active contact. In other alternative embodiments, a gaze controlled user interface may be utilised to set the active contact.

FIGS. 3A-3C depict operations of the electronic device of FIG. 1 according to example embodiments of the invention. In FIG. 3A, the contacts application is being executed and the contact application data item 204, 206, 208 associated with Carol Evans is being displayed.

As can be seen in FIG. 3A, the user selects the minimise option icon 210. In response to receiving an indication of the selection of the minimisation option icon 210, the controller 106 causes an identifier associated with the contact application data item currently being displayed on in the display unit 102 automatically to be stored in the memory. The controller 106 then causes the contact application to be minimised and, as can be seen in FIG. 3B, the menu screen to be displayed. Alternatively, the same actions can be achieved by the user selecting a ‘menu’ input, which may exist for instance as a hardware key or as a touchscreen input outside of the area of the display that is allocated to the contacts application.

In FIG. 3B, the user applies a touch input to the icon 202-4 representing the gallery application. Thus, the controller 106 causes the gallery application to be launched. During initialisation of the gallery application, the controller 106 determines if an identifier associated with a contact has been stored in dedicated field 108C of the memory 108. In response to determining that an identifier representing an active contact has been stored in the memory 108, the controller 106 causes gallery application data items associated with the stored identifier to be identified and displayed by the gallery application. Consequently, as can be seen in FIG. 3C, the gallery application includes pictures associated with (e.g. of or received from) Carol Evans to be displayed.

Thus, from the example embodiments of FIGS. 3A-3A, it will be understood that the controller 106 may not require an active user selection of a particular contact, but may instead automatically display data items in newly launched applications based on data items viewed in previously displayed applications. Also, although in FIG. 3A the user selects the minimise option icon 210, the controller may also be operable to store the identifier associated with the currently displayed data items in response to receiving an indication of selection of the exit icon 210.

The automatic displaying of data items based on data items displayed in previously executed application (as described with reference to FIGS. 3A to 3C) may not be desirable to the user at all times and thus the user of the electronic apparatus 10 may be able to disable this functionality using, for example, a menu option, or a setting in a general settings part of the user interface.

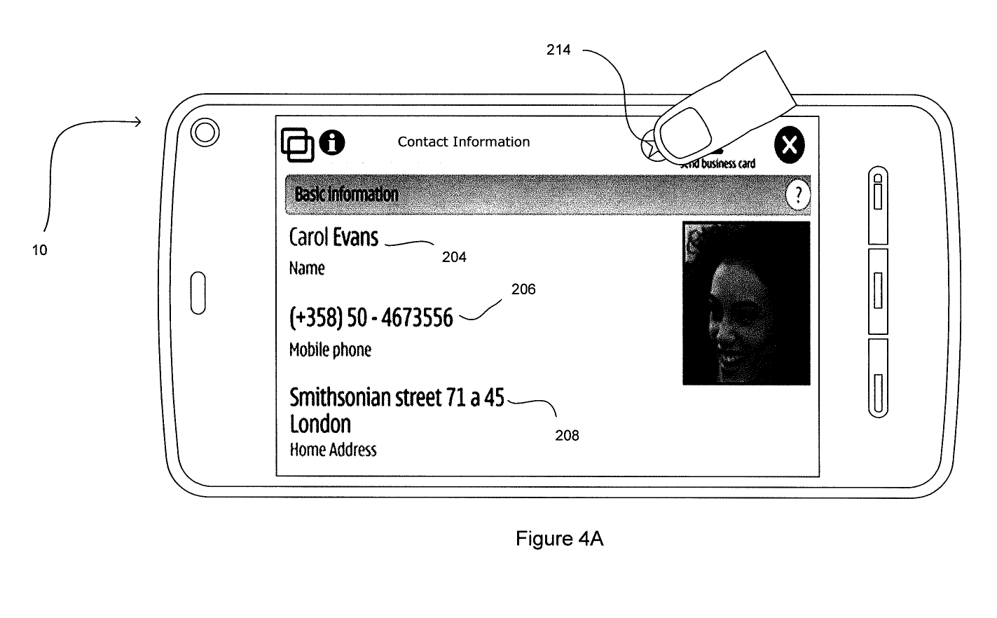

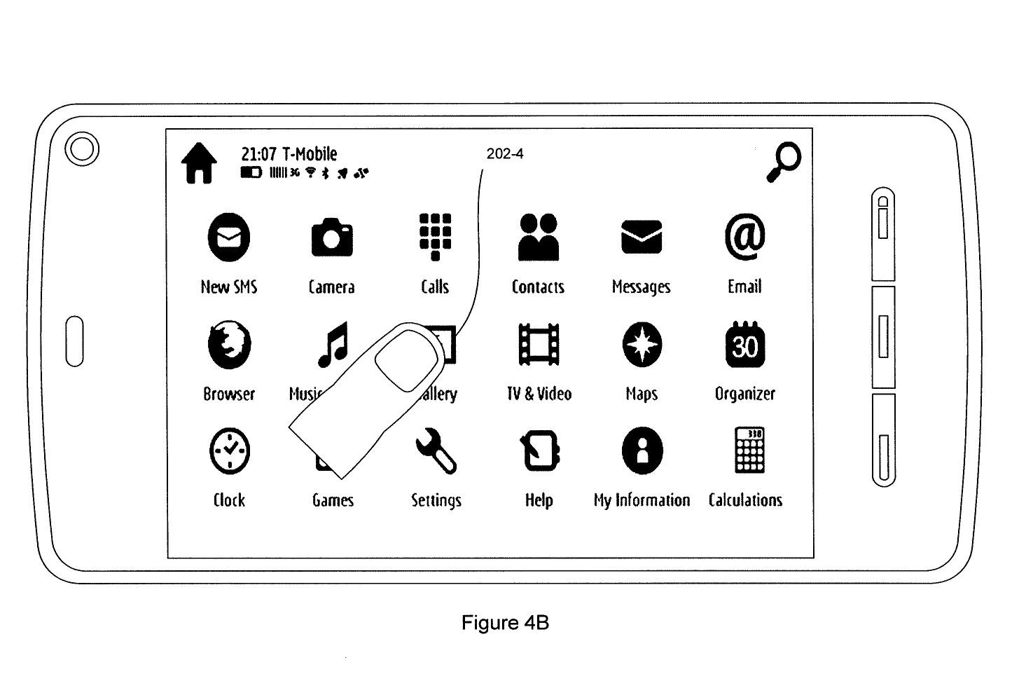

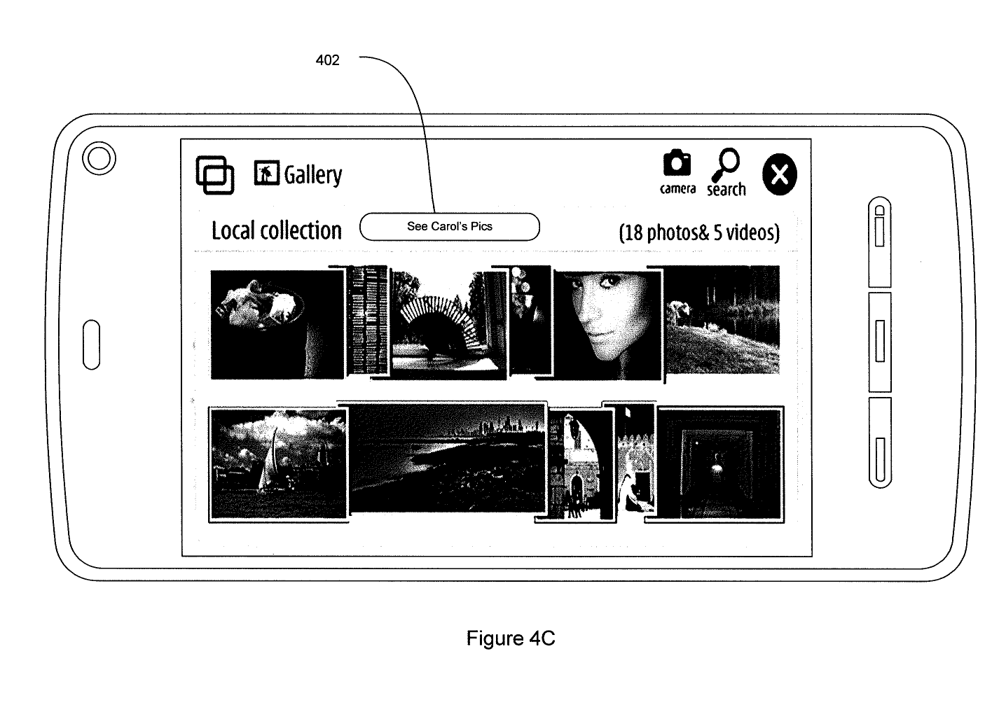

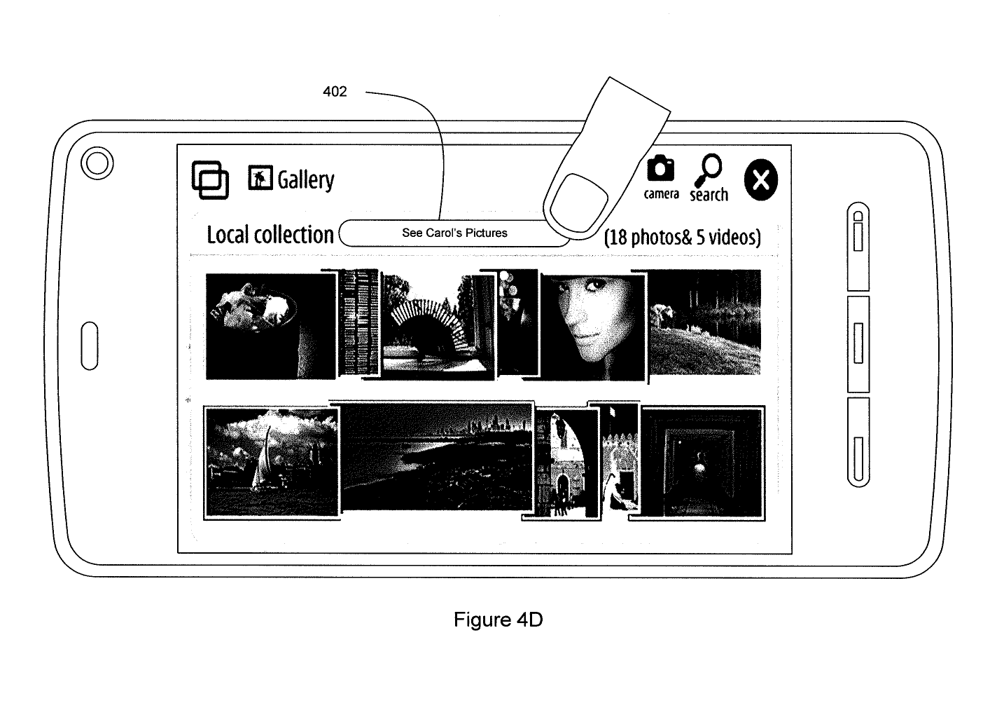

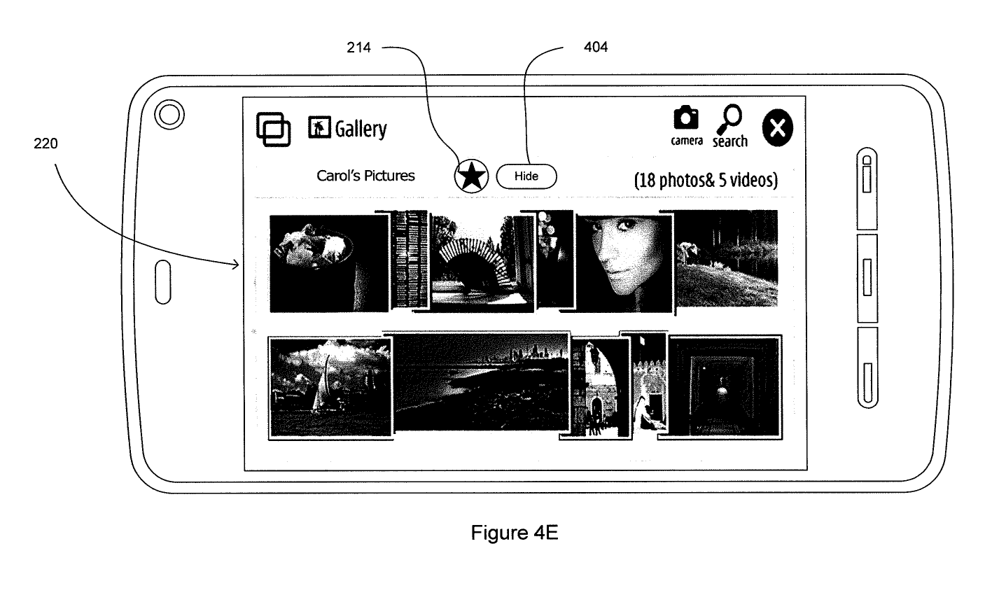

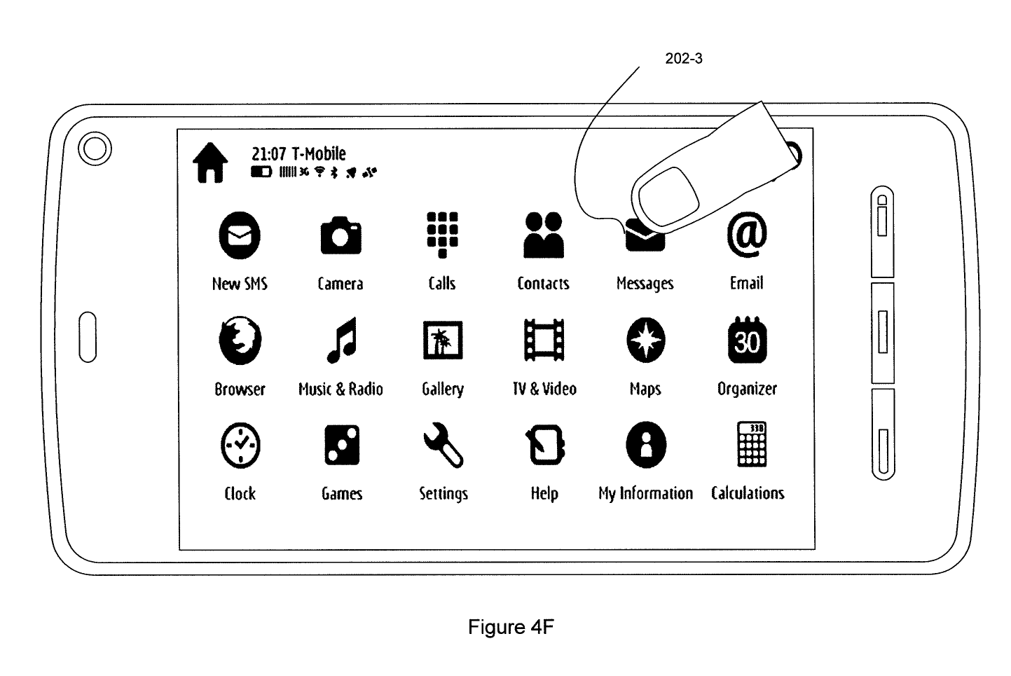

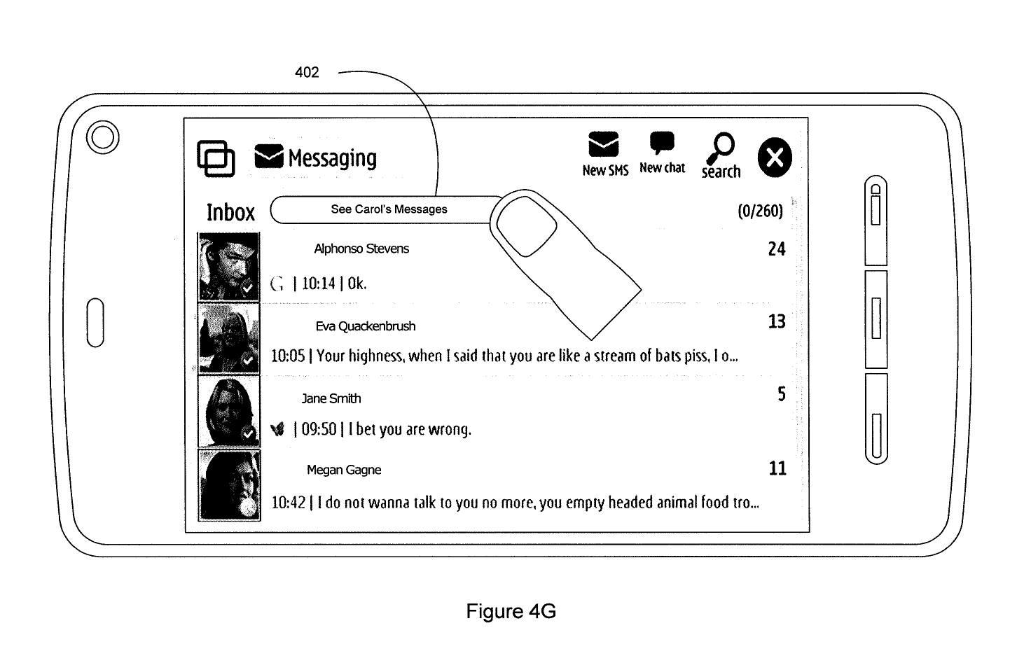

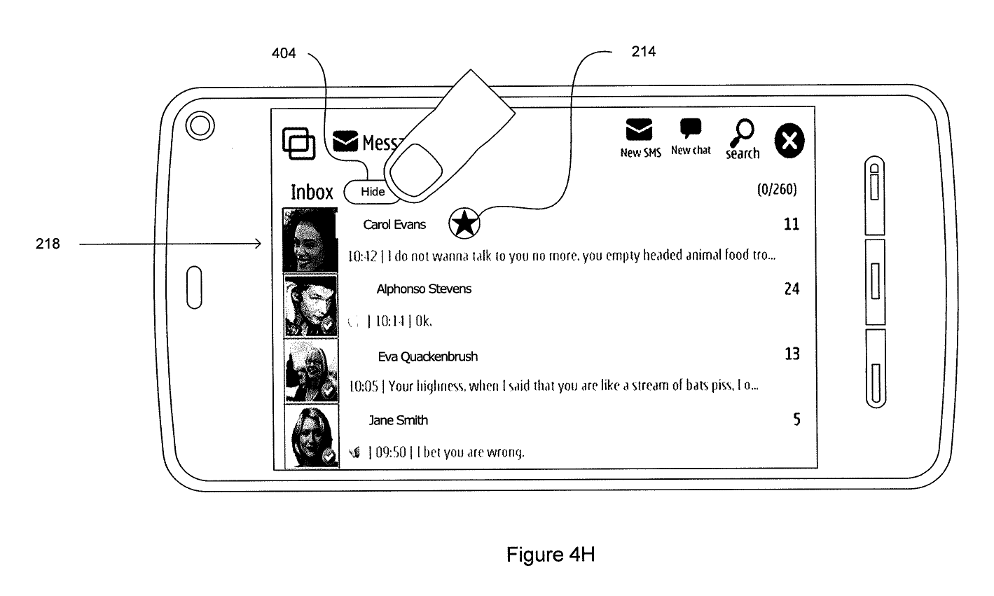

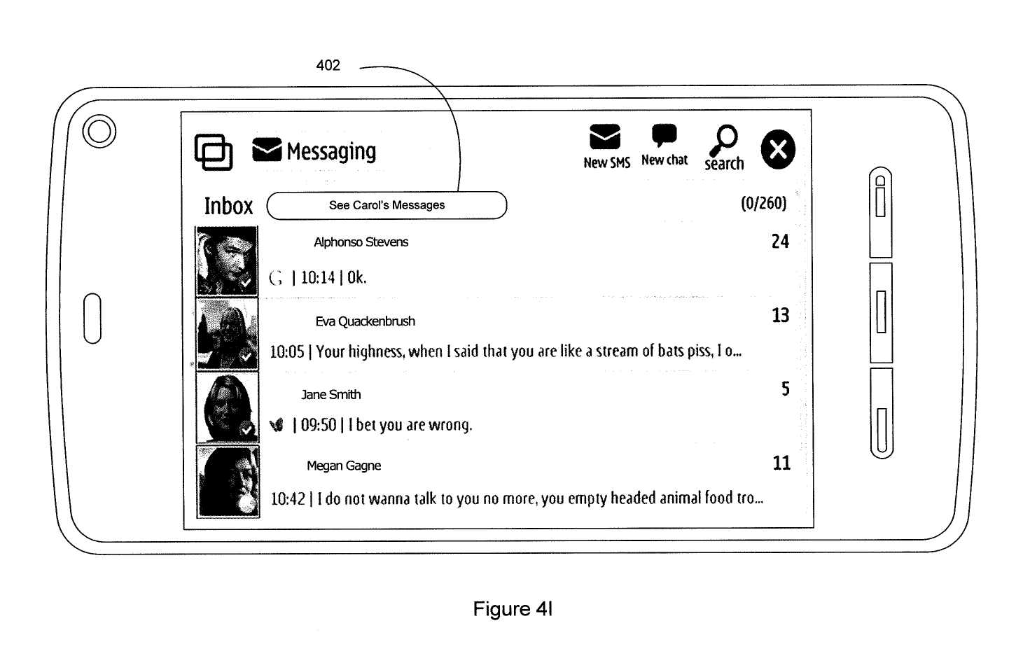

FIGS. 4A-4I depict operations of the electronic device of FIG. 1 according to example embodiments of the invention. In FIG. 4A, the contacts application is being executed and the contact application data item 204, 206, 208 associated with Carol Evans is being displayed. The user selects the set active contact icon 214, which causes an identifier associated with Carol Evans to be stored in the dedicated field 108C of the memory 108. Although not shown in FIG. 4A, the appearance of the set active contact icon may be changed in order to indicate that Carol Evans is now the active contact.

Next, in FIG. 4B and following a user input (not shown) to cause the contacts application to be removed from the screen, the menu screen is displayed and the user selects the icon 202-4 associated with the gallery application.

In response to detection of the selection of the icon 202-4 associated with the gallery application, the apparatus 10 launches the gallery application. During launching of the gallery application, the controller 106 determines if an identifier is stored in the dedicated field. According to this example embodiment, as can be seen in FIG. 4C, the controller 106 causes gallery-application-type data items, such as still images, to be displayed in a normal manner, for example based on an order in which the images were added to the gallery. However, in addition to this, the controller is responsive to a positive detection that an identifier is stored in the dedicated field 108C to display a first selectable option 402 on the display 102. The selectable option may, for example, include text indicating that selection of the selectable option will cause data items associated with the stored identifier (i.e. associated with the active contact) to be displayed. Thus, in the example of FIG. 4C, as the stored identifier is associated with Carol Evans, the selectable option is an icon including the text “See Carol's Pictures”. It will be appreciated that the first selectable option 402 may alternatively take another form.

In FIG. 4D, the user selects the first selectable option 402. In response to the detection of this selection, the controller 106 causes data items 220 associated with the stored identifier to be displayed on the display 102. Thus, in this example, as shown in FIG. 4E, images of or from Carol Evans are caused to be displayed on the display 102.

In the example shown in FIG. 4E, the display also indicates that the pictures displayed are associated with Carol Evans. Also, the first selectable option 402 is replaced by a second selectable option 404. Selection of the second selectable option 404 causes the data items 220 associated with the stored identifier to be removed from the display 102. In this example, the second selectable option 404 includes the text “Hide”. The controller 106 may also cause the set active contact icon 214 to be displayed. Selection of this icon may cause the currently active contact (i.e. Carol Evans) to be de-selected and, thus, the stored identifier associated with Carol Evans to be removed from the dedicated field 108C. However, in this example the user does not select the second selectable option 404 or the set active contact icon 214. Instead, although not shown in FIG. 4E, the user causes the first application to be removed from the display 102 and, as shown in FIG. 4F, the menu screen to be displayed. Subsequently, the user selects the icon 202-3 associated with the messaging application.

In response to selection of the icon 202-3 associated with the messing application, the controller 106 causes the messaging application to be launched. During initialisation of the messaging application, the controller 106 determines if an identifier is stored in the dedicated field. According to this example embodiment, as can be seen in FIG. 4G, the controller 106 causes messaging application-type data items, such as received text messages, to be displayed in a normal manner, for example based on an order in which the messages were received at the apparatus 10. In addition to this, the controller 106 is responsive to a positive detection that an identifier is stored in the dedicated field 108C to display the first selectable option 402 on the display 102. In this example, the first selectable option 402 is an icon including the text “See Carol's messages”.

In FIG. 4G, the user selects the first selectable option 402, and in response to this, the controller causes data items 218 (in this example, messages) associated with Carol Evans to displayed on the display 102. In addition, the controller 106 causes the first selectable option 402 to be replaced by the second selectable option 404. Also or alternatively, the controller 106 may cause the set active contact icon 214 to be displayed. In this instance, the set active contact icon 214 indicates that Carol Evans is the active contact. In FIG. 4H, the user selects the second selectable option 404.

As can be seen in FIG. 4I, in response to selection of the second selectable option 404, the controller 106 causes the data items 218 associated with the stored identifier to be removed from the display 102.

The example embodiments described with reference to FIGS. 4A to 4I, provide an easy way for a user to cause data items associated with a particular contact to be displayed when navigating from application to application. However, as it may not always be appropriate for data items associated with the active contact to be displayed upon initiating a new application, these example embodiments allow the user to choose in an simple manner whether they wish for the data items associated with the active contact to be displayed.

It will be appreciated that certain aspects and elements of the example embodiments described with reference to FIGS. 2A to 2S, 3A to 3C, and FIG. 4A to 4I may be combined. For example, it may be more appropriate for data items associated with the active contact to be displayed automatically for some applications, such as the gallery application, and for some applications, such the mapping application, it may be more appropriate to display the second selectable icon instead of automatically to the display the data items associated with the active contact. Also, although it is not shown in FIG. 3C, the set active contact icon 214 may be displayed to indicate which is the active contact and to allow the active contact to be deselected. It will be appreciated that these are just examples of the elements and aspects that may be combined, and it will be understood that any compatible combination of elements described above may be utilised.

According to alternative embodiments, the user may be able to select more than one active contact simultaneously. In such embodiments, data items associated with each active contact may be displayed on the display unit 102 automatically. Alternatively, the data items associated with only one contact may be displayed on the display unit 102 at any one time and a simple scrolling system may be used to allow the data items associated with another active contact to be easily accessed. In other alternative example embodiments, only data items associated with both active contacts may be displayed. These may include data items, such as images which include both active contacts, or data items such as documents upon which both contacts have worked.

The above-described operations allow the user easily to view information which is of interest to them. Thus, the user does not need to navigate through menu systems in order to find such information. This reduces the number of inputs that must be applied by the user and potentially increases the lifespan of the hardware of, for example, the user interface 104.

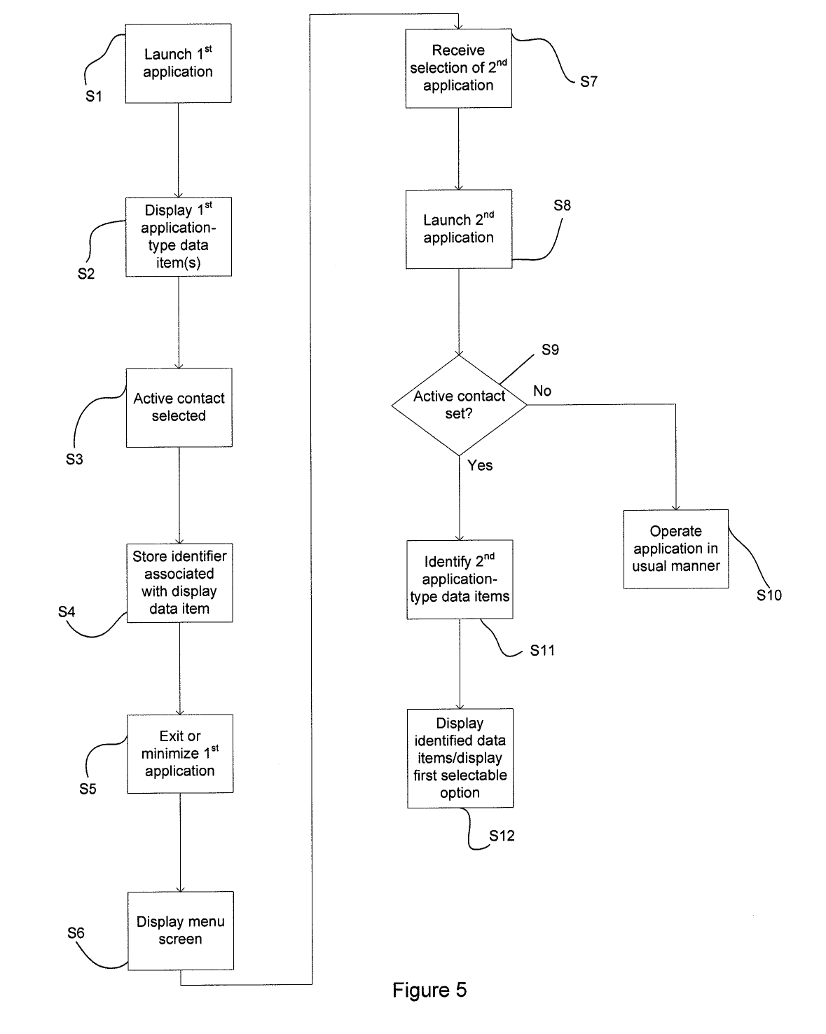

FIG. 5 is a flow chart depicting operations of the electronic apparatus 10 of FIG. 1 according to the example embodiments of the invention. In step S1, the controller 106 causes a first application to be launched. In the example of FIG. 2A, the first application is a contact application. However, it will be understood that the first application might be another application such as the gallery application, the messaging application or the map application.

Next, in step S2, a first application type data item is caused to be displayed. In the example of FIG. 2A, this comprises contact information 204, 206, 208. Next, in step S3, the controller 106 receives an indication of a selection of an option to make a contact associated with the currently displayed data item the active contact. As described with reference to FIGS. 2A-2S, this may be provided by selection of a displayed icon 214, or by an input having a particular gesture type.

In response to the operation of step S3, the controller 106 causes an identifier associated with the displayed data item to be stored in the memory 108, for example in the dedicated field 108C of the memory 108.

In step S5, the controller 106 receives a signal indicative of selection of a minimise option or an exit option. In step S6, in response to the operation of step S5, the controller 106 causes the first application to be minimised, exited or otherwise removed from the display unit 102 and the menu screen to be displayed.

Next, in step S7, an indication of the selection of a second application is received. In response to receiving selection of the second application, in step S8, the controller 106 causes the second application to be launched. In step S9, during initialisation of the second application, the controller 106 determines by examining, for example, the dedicated field 108C of the memory if a contact is currently set as an active contact.

If a negative determination is reached in step S9, the operation proceeds to step S10 in which, the controller 106 causes the second application to operate in its usual manner, for example, by displaying the most recently received second application-type data items.

If a positive determination is reached in step S9, the operation proceeds to step S11, in which second application-type data items which are associated with the stored identifier are identified from a plurality of second application-type data items.

In step S12, the controller 106 causes the identified second application type data items which are associated with the identifier to be displayed on the display unit 102. Alternatively, in step S12, the controller may cause the first selectable option 402 to be displayed. In such embodiments, the controller is responsive to selection of the first selectable option to cause the data items associated with the stored identifier to be displayed.

It will be understood, that according to the example embodiments, some steps of the operation described with reference to FIG. 4 may omitted and others may be re-ordered. For example, in the example embodiment described with reference to FIGS. 3A to 3C, step S3 of FIG. 4 may be omitted and step S4 may be performed after step S5.

According to some additional embodiments, the apparatus may be operable to store identifiers relating to deactivated contacts. Thus, when a contact is deactivated, for example in a manner similar to those described above in relation to setting an active contact, the apparatus may ensure that data items relating to deactivated contacts are not displayed on the display when executing a different application. Thus, an ex-partner of the user could be set as an inactive contact. When this has been done, when a new partner of the user is using the electronic apparatus 10, data items relating to the ex-partner, such as photos, messages etc, would not be displayed.

It will be appreciated that the invention is not limited to storing identifiers relating to active contacts. Thus, the identifier may be associated with another type of individual or entity. For example, the identifier may instead relate to a band or performer, whose songs or videos are played by a media player application (thus data items relating to that the band or performer are displayed on the display). Next, when a user navigates to a different application, data items associated with the band or performer may be displayed. These data items may include for example, in a gallery application, images of the band or performer, or in a mapping application the location of the band or performer's next performance.

Alternatively, the identifier may relate to a geographical location, such as a country. Thus, when a user is using a mapping application to view maps of, for example, England, an identifier associated with England may be stored. Subsequently, when a user navigates to another application such as the gallery application, images from a holiday to England may be caused to be displayed, or when navigating to a music player application, a list of songs by English performers may be displayed. It will be appreciated that these are non-limiting examples and that the skilled person would understand that the identifier may be associated with any number of different individuals or entities.

It should be realized that the foregoing embodiments should not be construed as limiting. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. Apparatus comprising:
at least one processor;
at least one memory including computer program code,
where the at least one memory and the computer program code are configured, with the at least one processor, to cause the apparatus at least:
to store an identifier associated with a first application-type data item that is caused to be displayed during execution and display of a first application; and
subsequent to removing the first application from the display, when executing a second application, automatically to cause a second application-type data item associated with the stored identifier to be displayed or automatically to cause to be displayed a selectable option, the selectable option being for causing a second application-type data item associated with the stored identifier to be displayed.

2. The apparatus of claim 1, wherein the at least one memory and the computer program code are configured, with the at least one processor, to cause the apparatus, subsequent to removing the first application from the display and prior to executing the second application, to display an array of user selectable icons, each of the icons being associated with a different one of a plurality of other applications.

3. The apparatus of claim 2, wherein the at least one memory and the computer program code are configured, with the at least one processor, to cause the apparatus to execute the second application in response to receiving an indication of a user selection of one of said user-selectable icons.

4. The apparatus of claim 1, wherein the at least one memory and the computer program code are configured, with the at least one processor, to cause the apparatus to store the identifier in response to receipt of a user input.

5. The apparatus of claim 4, wherein the user input comprises selection of an option to remove the first application from the display.

6. The apparatus of claim 1, wherein being configured to automatically cause the second application-type data item associated with the stored identifier to be displayed comprises being configured to identify the second application-type data item associated with the stored identifier from a plurality of other second application-type data items.

7. The apparatus of claim 1, where the at least one memory and the computer program code are configured, with the at least one processor, to cause the apparatus automatically to cause the second application-type data item associated with the stored identifier to be displayed in response to a determination that the identifier is stored in the at least one memory.

8. The apparatus of claim 1, wherein the at least one memory and the computer program code are configured, with the at least one processor, to cause the apparatus:
subsequent to removing the first application from the display, when executing a second application, automatically to cause to be displayed a selectable option, the selectable option being for causing a second application-type data item associated with the stored identifier to be displayed; and
to be responsive to selection of the selectable option to cause the second application-type data item to be displayed.

9. The apparatus of claim 1, wherein the at least one memory and the computer program code are configured, with the at least one processor, to cause the apparatus to cause the second application-type data item associated with the stored identifier to be displayed along with other second application-type data items, wherein the second application-type data item associated with the stored identifier is displayed in a more prominent manner than the other second application-type data items.

10. The apparatus of claim 1, wherein at least one of the first application-type data item and the second application-type data item is selected from a group comprising:
a contact;
a message; and
a gallery image.

11. A method comprising:
storing an identifier associated with a first application-type data item that is caused to be displayed during execution and display of a first application; and
subsequent to removing the first application from the display, when executing a second application, automatically causing a second application-type data item associated with the stored identifier to be displayed or automatically causing to be displayed a selectable option, the selectable option being for causing a second application-type data item associated with the stored identifier to be displayed.

12. The method of claim 11 comprising, subsequent to removing the first application from the display and prior to executing the second application, displaying an array of user selectable icons, each of the icons being associated with a different one of a plurality of other applications.

13. The method of claim 12 comprising executing the second application in response to receiving an indication of a user selection of one of said user-selectable icons.

14. The method of claim 11 comprising storing the identifier in response to receipt of a user input.

15. The method of claim 11 wherein automatically causing the second application-type data item associated with the stored identifier to be displayed comprises identifying the second application-type data item associated with the stored identifier from a plurality of other second application-type data items.

16. The method of claim 11 comprising automatically causing the second application-type data item associated with the stored identifier to be displayed in response to a determination that the identifier is stored in the at least one memory.

17. The method of claim 11 comprising:
subsequent to removing the first application from the display, when executing a second application, automatically causing to be displayed a selectable option, the selectable option being for causing a second application-type data item associated with the stored identifier to be displayed; and
responding to selection of the selectable option, by causing the second application-type data item to be displayed.

18. The method of claim 11 comprising causing the second application-type data item associated with the stored identifier to be displayed along with other second application-type data items, and causing the second application-type data item associated with the stored identifier is displayed in a more prominent manner than the other second application-type data items.

19. The method of claim 11, wherein at least one of the first application-type data item and the second application-type data item is selected from a group comprising:
a contact;
a message; and
a gallery image.

20. A non-transitory computer-readable storage medium having stored thereon computer-readable code, which, when executed by computing apparatus, causes the computing apparatus, during a communication session with remote apparatus:
to store an identifier associated with a first application-type data item that is caused to be displayed during execution and display of a first application; and
subsequent to removing the first application from the display, when executing a second application, automatically to cause a second application-type data item associated with the stored identifier to be displayed or automatically to cause to be displayed a selectable option, the selectable option being for causing a second application-type data item associated with the stored identifier to be displayed.

21-22. (canceled)
